(19) United States
(12) Patent Application Publication
(10) Pub. No.: US 2014/0038526 A1
(43) Pub. Date: Feb. 6, 2014

(54) Mobile Social Media Platform and Devices

(71) Applicants: Louis C. ENNIS, Reston, VA (US); Riley ENNIS, McLean, VA (US); Lawrence M. STANLEY, Leesburg, VA (US)

(72) Inventors: Louis C. ENNIS, Reston, VA (US); Riley ENNIS, McLean, VA (US); Lawrence M. STANLEY, Leesburg, VA (US)

(21) Appl. No.: 13/959,606

(22) Filed: Aug. 5, 2013

Related U.S. Application Data
(60) Provisional application No. 61/679,087, filed on Aug. 3, 2012.

(51) Int. Cl. H04W 4/00

(52) U.S. Cl. CPC H04W 4/005
USPC 455/41.2

(57) ABSTRACT

Methods, systems, and devices are presented relating to networking through a wireless mesh network. The method comprises pairing a first handheld device with a first machine to machine networking device associated with a first user and pairing a second handheld device with a second machine to machine networking device associated with a second user. The method further comprises matching the first user with at least the second user over a wireless mesh network and communicating the match to at least the first user. The matching of users can involve determining the first and second user have at least one defined preference in common.

### CROSS-REFERENCE TO RELATED APPLICATION

This application claims priority to U.S. Provisional Patent Application No. 61/679,087 entitled “Mobile Social Media Platform and Associated Connection Devices,” filed on Aug. 3, 2012, which is hereby incorporated by reference in its entirety.

### TECHNICAL FIELD

The present embodiments relate to the field of social networking systems and methods.

### BACKGROUND

Today's internet connects billions of devices including servers, personal computers, smartphones, and tablets. Recent discussion has focused on a new wave of connected devices—called the “Internet of Things” (“IoT”). These simpler, smaller, connectable devices are contemplated to collect small amounts of data, connect with other similar devices if necessary, and pass collected data on to more traditional computers for processing.

One such set of devices is being called machine-to-machine (“M2M”). M2M devices collect small amounts of data from disparate locations, share this data among small remote “machines,” and send this data back to larger software and servers for processing. Present uses of M2M technology are in their infancy, in the form of “pilot programs” being tested in the following markets: utility companies testing “smartgrid” or power meter automation, car companies designing “connected cars,” home automation companies designing “connected homes,” and medical device companies designing patient monitoring systems.

Experimentation with M2M technology for other business and consumer markets and applications has been extremely limited. Early M2M designs have focused on connecting machines rather than people. M2M, having been created for data collection-oriented, machine-to-machine applications, can also serve as a data conduit for “person-to-person” data collection and communication. Today, person-to-person communication, in mobile settings, happens largely over the mobile internet and cellular connections. They work best out-of-doors, given that cellular towers and GPS signals reside there. One big limitation of cellular and GPS systems, however, is that they have been designed and deployed for outdoor communications, where they receive signals from towers (cellular) and satellites (GPS). Given this outdoor orientation, they sometimes perform poorly indoors due to loss of cellular signal, GPS signal, or both. Anyone who has been to a large indoor convention can attest to the problems inherent in indoor communications in cavernous halls with many people milling around. Furthermore, today's “social networking” applications rely on cellular, GPS, and other “location tracking” systems to facilitate connecting people to other people and businesses around them.

M2M technology itself enables simple “off-grid” (limited or no cellular coverage; no GPS signal) connections and communications, having been designed to function both indoors and outdoors. There are no towers or satellites required, as M2M deployments are purposefully self-sufficient and self-contained. Therefore, M2M connections in the hands of businesspeople carrying M2M devices embedded in handhelds (e.g., smartphones), could facilitate more reliable data connections for simple, text-message-like communications. This patent describes the use of M2M technology that is novel and complementary to current cellular and GPS technology in order to create a new person-to-person communication network.

### SUMMARY OF THE INVENTION

Effective and efficient methods, systems, and devices are presented. In some embodiments, a method of using a wireless mesh network for networking comprises pairing a first handheld device with a first machine to machine networking device associated with a first user, pairing a second handheld device with a second machine to machine networking device associated with a second user, matching the first user with at least the second user over a wireless mesh network, and communicating the match to at least the first user.

In some embodiments, machine to machine networking devices comprise a first radio for communicating with the handheld device, and a second radio for communicating with other machine to machine networking devices. The first radio can be an IEEE 802.15.4 communication module. The second radio can be a Bluetooth Low Energy communication module. The machine to machine networking devices can further include an integrated power source and a microprocessor.

The matching of users can involve determining the first and second user have at least one defined preference in common. The defined preference may include a preferred time of day to meet users. The defined preference can also include a recommended location to meet users. The wireless mesh network can involve machine to machine networking devices communicating within a defined range. The communication range can be less than one hundred meters. The machine to machine networking device can be integrated into the first handheld device. The handheld device can be a smartphone, tablet, or personal digital assistant. The first handheld device can be paired to only one machine to machine device at one time. The machine to machine networking devices can further communicate using text messages. The users may be matched if they are in proximity to each other. Users may be in proximity to each other if their machine to machine devices are part of the same wireless mesh network. Users may further be in proximity to each other if they are less than one hundred meters apart.

In some embodiments, a machine to machine network device for enabling social networking between individuals through mesh networking comprises a microprocessor, a power source, a first radio comprising a Bluetooth Low Energy communication module for communicating with a handheld device, and a second radio comprising an IEEE 802.15.4 communication module for communicating with other machine to machine devices. In some embodiments, the machine to machine networking device can be integrated into a handheld device. The microprocessor can be programmed to connect the first radio to one handheld device at a time. The handheld device can be a smartphone, table, or personal digital assistant.

In some embodiments, a system for social networking via a wireless mesh network comprises a first handheld device paired to a first machine to machine communication device associated with a first user, a second handheld device paired to a second machine to machine communication device associated with a second user, wherein the first user is matched with at least the second user over a wireless mesh network and wherein the match is communicated to at least the first user.

In some embodiments, each machine to machine communication device comprises a first radio configured to communicate with the handheld device, and a second radio configured to communicate with other machine to machine devices. In some embodiments, the first radio can be an IEEE 802.15.4 communication module. The second radio can be a Bluetooth Low Energy communication module. The machine to machine networking devices can further include an integrated power source and a microprocessor. The matching of users can involve determining the first and second user have at least one defined preference in common. The defined preference may include a preferred time of day to meet users. The defined preference can also include a recommended location to meet users. The wireless mesh network can involve machine to machine networking devices communicating within a defined range. The communication range can be less than one hundred meters. The machine to machine networking device can be integrated into the first handheld device. The handheld device can be a smartphone, tablet, or personal digital assistant. The first handheld device can paired to only one machine to machine device at one time, or it can be paired to a plurality of machine to machine devices at one time. The machine to machine networking devices can further communicate using text messages. The users may be matched if they are in proximity to each other. Users may in proximity to each other if their machine to machine devices are part of the same wireless mesh network. Users may further be in proximity to each other if they are less than one hundred meters apart.

### BRIEF DESCRIPTION OF FIGURES

FIG. 1 is a block diagram of an exemplary environment showing connections between an M2M device, a handheld, and a web server in accordance with one embodiment of the present invention.

FIG. 2 is a block diagram of the components and connections of an M2M device in accordance with one embodiment of the present invention.

FIG. 3 is a photograph of an exemplary M2M device in accordance with one embodiment of the present invention.

FIG. 4 is a block diagram of an exemplary interconnected environment of M2M devices and handheld devices in accordance with one embodiment of the present invention.

FIG. 5 is a block diagram of an exemplary environment implementing a mesh network with M2M devices and handheld devices in accordance with one embodiment of the present invention.

FIG. 6 is a block diagram of another exemplary environment in accordance with one embodiment of the present invention.

FIG. 7 is a flowchart of a user's interaction with the system in accordance with one embodiment of the present invention.

FIG. 8 is a flowchart of the process of using the system in accordance with one embodiment of the present invention.

FIG. 9 is a flowchart of the process of matching proximate users using predefined preferences in accordance with one embodiment of the present invention.

### DETAILED DESCRIPTION

Detailed reference will now be made to the preferred embodiments. The specific detail disclosed herein is intended to provide a thorough disclosure. Although reference will be made to these preferred embodiments, they are not intended to limit the invention to these specific embodiments, and it should be understood that these specific details are not necessary to practice the invention.

This patent proposes an M2M business networking platform that uses M2M technology to enable businesses and consumers to collect and share data between small M2M devices, handheld computers, and internet-based servers for the purposes of more effective business and personal networking. In one embodiment, the system includes small M2M devices that communicate text-only data, applications that capture and share this data on smartphone/tablet devices, and remote web servers that process this data. Software created for each subsystem (M2M Device, Handheld Device, and Web Servers) enables each subsystem to connect and communicate with each other. It also includes the specialized Web Services platform that captures, shares, stores, and processes this data.

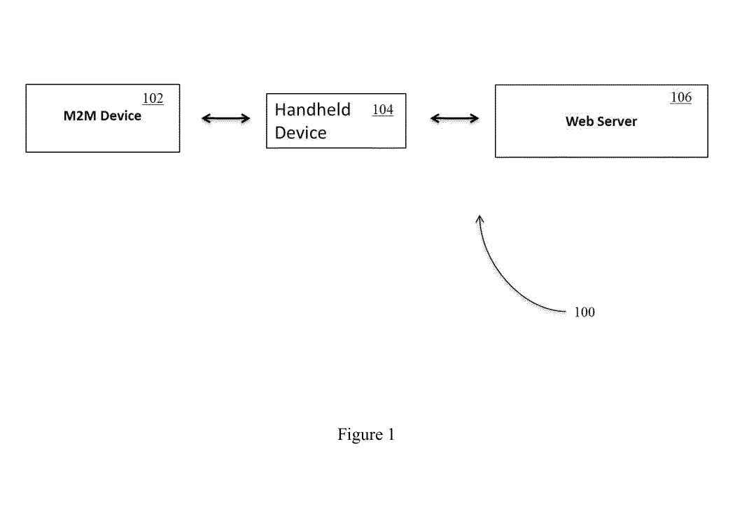

FIG. 1 is a block diagram of an exemplary environment showing connections between an M2M Device, a Handheld Device, and a Web Server. The environment 100 includes M2M Device 102, Handheld Device 104, and Web Server 106. In one embodiment, M2M Device 102 interfaces with Handheld Device 104 to form a paired connection. Handheld Device 104 further communicates with Web Server 106. In one exemplary implementation, the connection between M2M Device 102 and Handheld Device 104 is formed using the Bluetooth Low Energy (BLE) communication protocol, and the connection between Handheld Device 104 and Web Server 106 is performed using conventional interfaces between a Handheld Device and the Internet (e.g., cellular (4G) or 802.11 WI-FI).

### M2M Device (Including Resident Software)

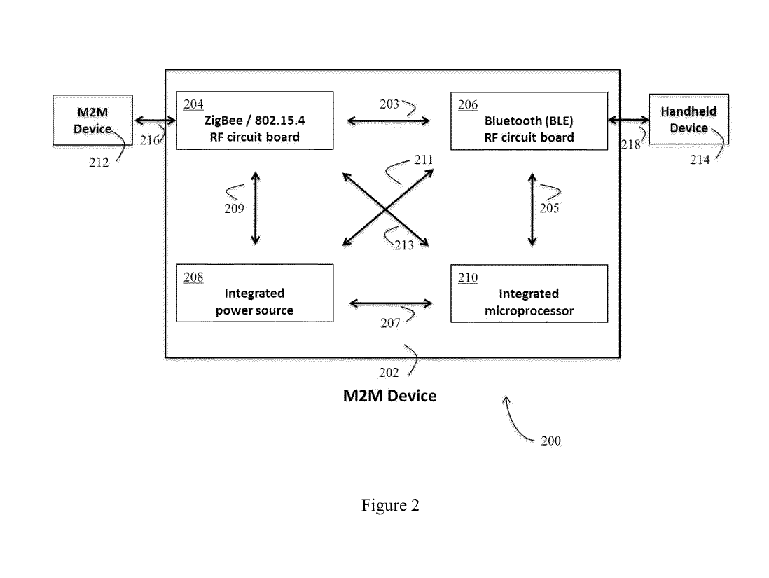

FIG. 2 is a block diagram describing an embodiment of M2M Device 202 functionality and capability. Each M2M Device comprises at least four specific elements: ZigBee/802.15.4 RF Circuit Board 204, Bluetooth Low Energy (BLE) RF Circuit Board 206, Integrated Power Source 208, and Integrated Microprocessor 210. ZigBee is an ad-hoc communication protocol optimized for low power communications implemented over the IEEE 802.15.4 standard. Bluetooth Low Energy (BLE) is a version of the Bluetooth protocol also optimized for low power communications. It is appreciated that the circuit boards 204 and 206 could include other types of radios for communication. Each of the four elements work together, and interact with each other to provide the integrated functionality and capability of each M2M Device subsystem.

M2M Device element 204 is an RF Circuit board that houses a ZigBee/802.15.4 chipset and associated electronics. This RF circuit board communicates internally (to the other internal M2M Device elements), as well as externally 216 with other M2M Devices. For example, M2M Device 212 may establish external connectivity between other proximate M2M Devices, e.g., 202.

M2M Device element 206 is an RF Circuit board that houses a Bluetooth Low Energy (“BLE”) chipset and associated electronics. This RF circuit board also communicates internally to the other internal M2M Device elements as well as externally 218 to establish connectivity with its mated pair Handheld Device 214. The connectivity and interactivity between these two (2) internal RF elements 204 and 206 enables overall data passage between M2M Device/Handheld Device mated pairs, as well as between other proximate M2M Device/Handheld Device mated pairs within the overall system.

M2M Device element 208 is an Integrated Power Source and element 210 is an Integrated Microprocessor. These elements also support and enable M2M Device performance so that each M2M Device can mate, pair, and pass data internally and externally. All other internal data connection arrows (203, 205, 207, 209, 211, 213) represent the frequent interactions between these four major components of the M2M Device subsystem, each component interacting to power, process, and communicate internally and externally.

In other embodiments of M2M Device 202 capability, these same elements can be found in a variety of form factors, including form factors that embed or insert this same functionality within the Handheld Devices (smartphones, tablets) themselves. These embedded or inserted form factors include, but are not limited to, mini-, micro-, or nano-SD cards or other standard form factors used by smartphones and tablets.

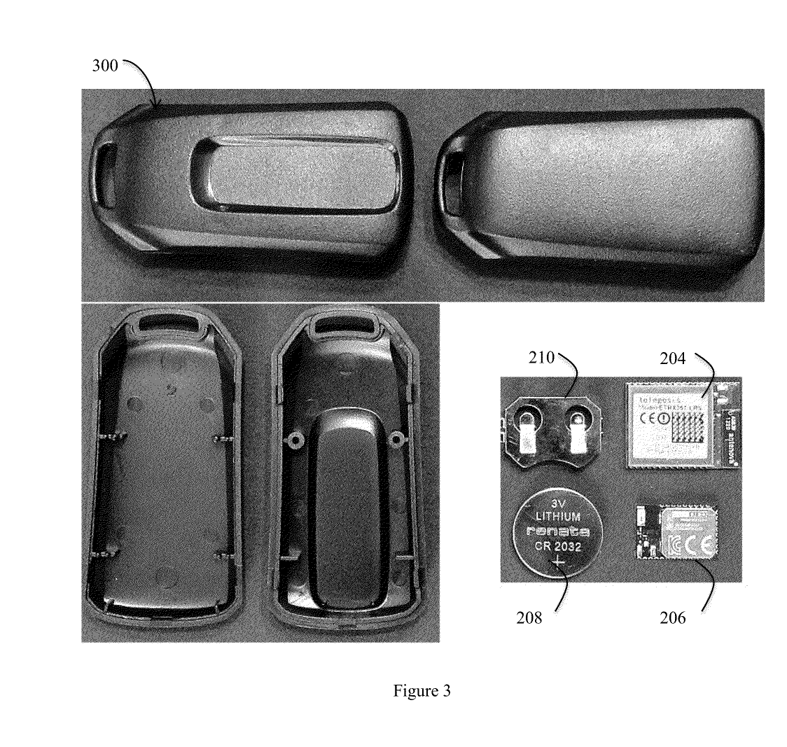

FIG. 3 is a photograph of an exemplary implementation of the M2M Device 200. M2M Device 300 includes ZigBee/802.15.4 RF Circuit Board 204, Bluetooth Low Energy (BLE) RF Circuit Board 206, Integrated Power Source 208, and Integrated Microprocessor 210. The components may be assembled to form the implementation presented by M2M Device 200 in FIG. 2.

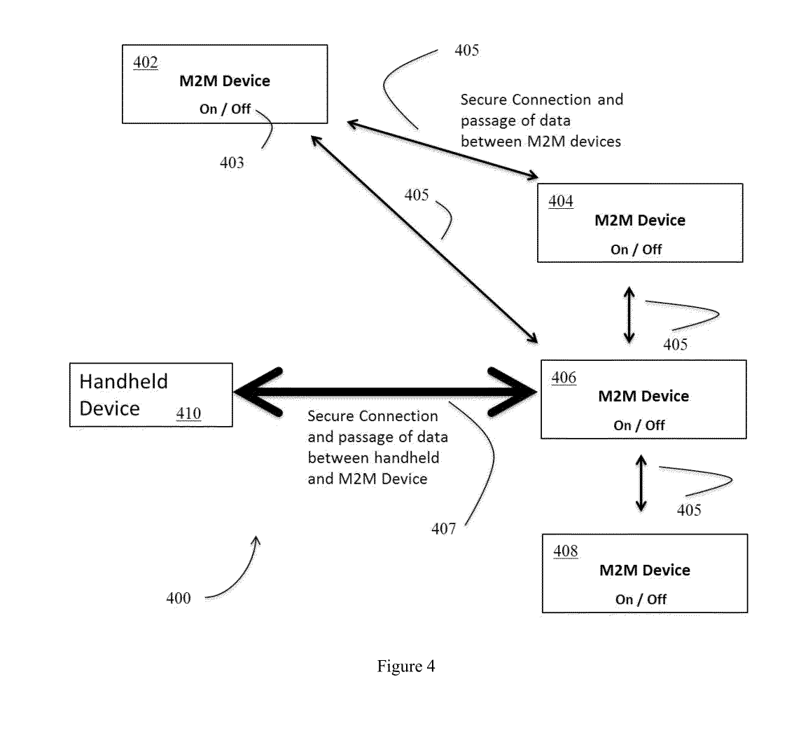

FIG. 4 is a block diagram of an embodiment of M2M Device functionality and capability. M2M environment 400 includes M2M Device 402, M2M Device 404, M2M Device 406, M2M Device 408, and Handheld Device 410. The M2M Device 402 turns itself on and off using a polling algorithm. Each M2M device acts as a beacon, periodically awakening and emitting a signal looking for like devices nearby and, when one device becomes proximate to one or more other devices that are on the same M2M network (i.e., are configured with the same identification, authorization, authentication, and acceptance algorithm as all other Systems on the network), then these devices can connect and wirelessly pass data over a secure data connection 405.

The M2M Device 402 establishes a secure connection with M2M Device 404 and can then pass data between M2M Device 402 and M2M Device 404. M2M Device 404 can also establish one or more connections with other authorized M2M Devices near it (e.g., M2M Devices 406, 408). Each of these M2M Devices establishes connections and passes data in the same manner with each other over a secure data connection 405. In addition, each of the M2M Devices (402, 404, 406, 408) can create a different, unique connection 407 with a Handheld Device 410. Handheld Devices may use, but are not limited to, all major mobile computing platforms, including iOS, Android, Windows, and Blackberry. The connection between an M2M device and a Handheld Device is different than the connection established between M2M Devices. In one embodiment, the connection between a Handheld Device subsystem and an accompanying M2M Device subsystem is conducted over the Bluetooth Low Energy (BLE) chipset within the M2M Device, whereas the M2M connection (M2M Device-to-another-M2M Device) is conducted over a ZigBee/802.15.4 connection.

### Handheld Device (Including Resident Software)

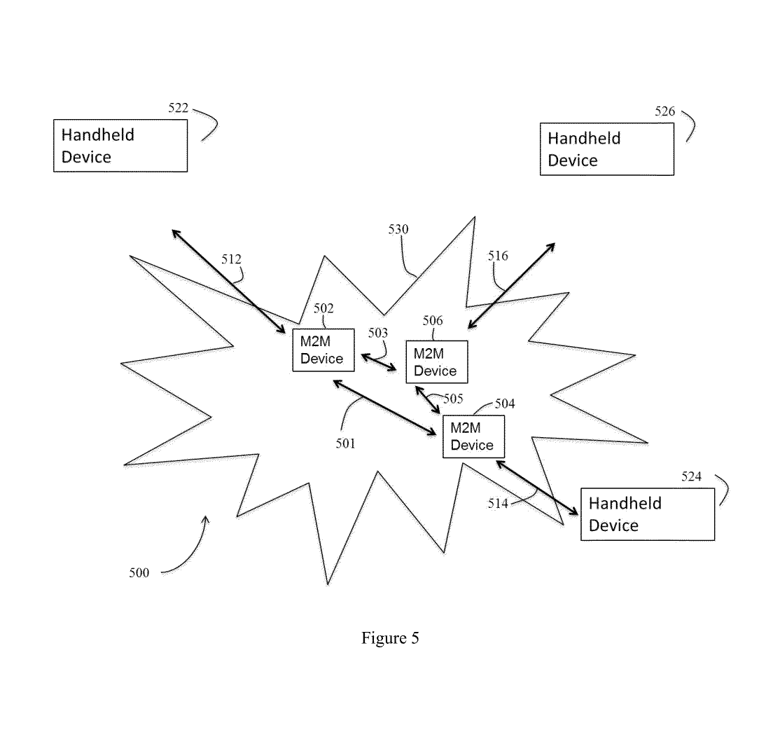

FIG. 5 is a block diagram of an embodiment of a Handheld Device Subsystem and associated mesh network. Handheld Device Subsystem and associated mesh network 500 includes M2M device 502, M2M device 504, M2M device 506, Handheld Device 522, Handheld Device 524, and Handheld Device 526. In this embodiment, each handheld device 522, 524, 526 connects with a corresponding M2M device 502, 504, 506, respectively, in a “one-to-one” connection 512, 514, 516, respectively. In this embodiment, each Handheld Device 522, 524, 526 will be “paired” with one and only one M2M Device 502, 504, 506 at a time. Handheld Device 522 pairs 1:1 with M2M device 502 via wireless connection 512, Handheld Device 524 pairs 1:1 with M2M device 504 via wireless connection 514, and Handheld Device 526 pairs 1:1 with M2M device 506 via wireless connection 516.

The Handheld Device uses a polling algorithm that, when activated, senses if there is an M2M Device in proximity to it (for example, within ten meters), and if so, generates a secure identity key which allows the devices to authenticate each other and connect. The M2M Device protocol is stored on the Handheld Device, and each time the M2M device becomes proximate to the Handheld Device, the two Devices can pair and pass data, forming a M2M Device/Handheld Device paired combination and associated 1:1 connection 512, 514, 516. All such mated pairs of M2M Devices/Handheld Devices are part of a temporarily created mesh network 530 of M2M Device/Handheld Device paired combinations. A mesh network is one in which devices not only send and receive their own data, but are also responsible for forwarding data to and from other nodes in the network. In this mesh network, M2M devices may send and receive data, as well as act as conduits for the passage of data to and from other M2M devices.

As a result, only those authorized M2M Device/Handheld Device paired combinations in the mesh network are capable of forming mesh network connections 501, 503, 505 via the associated M2M device 502, 504, 506 of each paired combination, connecting M2M

Device/Handheld Device paired combinations with similarly-configured M2M Device/Handheld Device paired combinations. A mesh network event occurs within the System when multiple (more than two) M2M Devices connect within the proposed System at the same time. It refers to any scenario where one M2M Device connects with one other M2M device (i.e., a 1:1 mesh connection), when one M2M Device connects to more than one other M2M Device (i.e., a 1:Many mesh connection), or when more than one M2M Device connects with more than one other M2M Devices (i.e., a Many:Many mesh connection).

In some embodiments, between any two or more System M2M Devices, an encryption protocol generates identity and authentication “keys” that are passed and maintained while devices are connected. In one exemplary implementation, these keys are issued in accordance with the RSA public key encryption standard. Likewise, a different key exchange algorithm is generated between any Handheld Device subsystem, and its accompanying M2M Device subsystem. In one exemplary implementation, these keys are also issued in accordance with the RSA public key encryption standard. Once the devices move far enough away from each other, the connection breaks and the devices are no longer able to communicate. These connect/communicate/disconnect sessions can happen frequently (in a matter of seconds or milliseconds).

In some embodiments, M2M Devices can be connected to more than one additional M2M Device at a time. M2M Devices can also use other similarly configured devices to “route” data across several devices via a mesh network, all using the same identity/authentication/security algorithm and protocol.

In some embodiments, the M2M Device is used as a conduit to pass data to and from the associated, mated Handheld Device as enabled by resident software on each Device. Once paired, each paired M2M Device/Handheld Device is able to pass data wirelessly to other similarly configured M2M Device/Handheld Device paired combinations. In this way, the M2M device permits different Handheld Devices to exchange data via a mesh network. This can be accomplished when other means of communication (e.g., cellular 4G, or WI-FI) are unavailable. In one exemplary embodiment, the data passed will be in the form of simple, text-only messages.

In one embodiment, these M2M Device/Handheld Device paired combinations are further capable of self-creating wireless mesh networks 530 of M2M Device/Handheld Device combinations. The network is created in the background (without intervention by the user) and devices will automatically find one another when in communication range. The communicating M2M devices will then pair M2M to M2M if they pass authentication. The device pairs can communicate and pass data via wireless mesh network connections 501, 503, 505 to and from other similarly configured, but uniquely paired M2M Device/Handheld Device combinations in “one-to-one” (1:1) configurations or in “one-to-many” (1:M) configurations, in which an M2M device connects to more than one other M2M device.

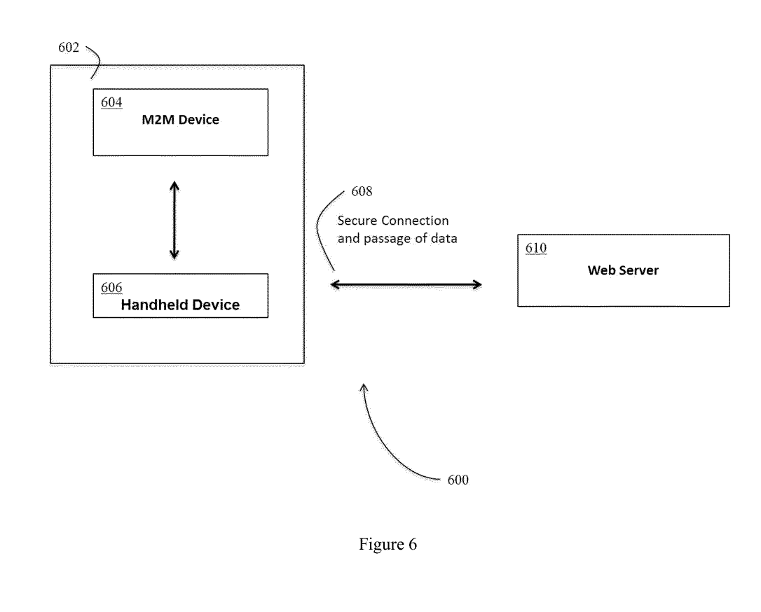

FIG. 6 is a block diagram of embodiments of additional Handheld Device functionality and capability. An embodiment of an interconnected M2M environment 600 includes Handheld Device Subsytem 602, which includes M2M Device 604 and Handheld Device 606. Web Server 610 establishes a secure connection with and enables passage of data 608 to and from the Handheld Device Subsystem 602. The secure connection 608 between the Handheld Device Subsystem 602 and the Web Server 610 is established through wired or wireless, public and/or private, network connections over the Internet. In one embodiment, the connections are cellular (e.g., 4G). In another embodiment, the connections are over either unsecured or WEP, WPA, or WPA2 secured 802.11 WI-FI. Once a standard connection is established, and unique Handheld Device subsystem 602 Web Server subsystem 610 security, authentication, and access has been granted to establish a Secure Connection 608, sanctioned Handheld Devices 606 and the Web Server environment 610 can connect, exchange data, and store and query data.

### Web Server Environment (Including Device-Resident, Cloud, and 3^{rd} Party Premise-Based Services)

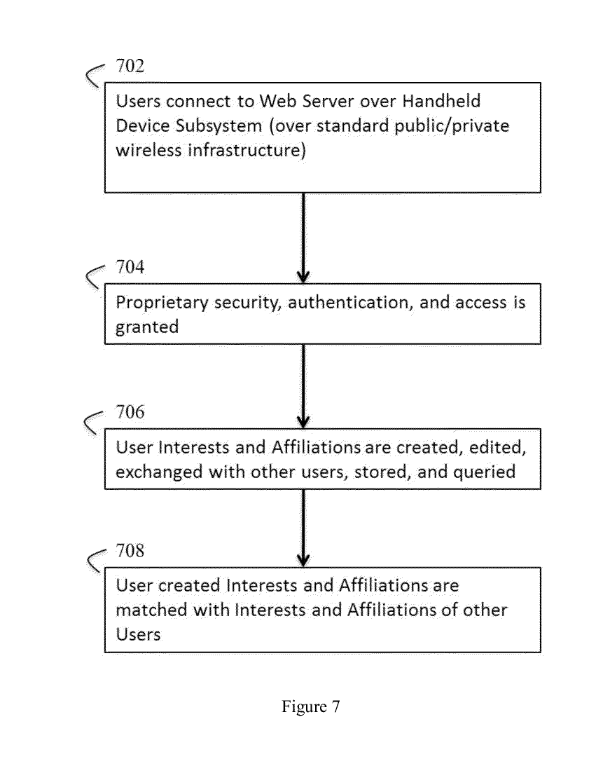

FIG. 7 is a flow diagram of an embodiment of the Web Server/Services environment (including device-resident, cloud, and 3^{rd} party premise-based services). At step 702 users connect to the Web Server over Handheld Device Subsystem (over standard public/private wireless infrastructure). Users may choose how to connect the Handheld Device Subsystem to the back-end Web Server subsystem. These connectivity options include generally available internet-wired and wireless public and/or private connections. Step 702 concludes once a connection between Handheld Device and Web Server is established.

At step 704 security, identity keys are exchanged, and device authentication and access is granted to the Handheld Device subsystem/Web Server subsystem in accordance with the description in FIG. 4 This enables sanctioned Handheld Devices and the Web Server environment to exchange data within the System. In one embodiment, access is controlled using the RSA implementation of public key cryptography.

At step 706 user data is created, edited, exchanged with other users, stored, and queried. The Web Server environment creates unique user profiles for each Handheld Device user, manages messaging traffic from Handheld Devices, captures and stores messages and other user-created data (for example, the information within User Profiles), and allows users to query their data resident in the Web Services environment.

At step 708 user created Interests and Affiliations are matched with Interests and Affiliations of other Users. The Web Services environment enables user Interest and Affiliation matching with other users, on a per user basis, for users that are proximate to other System users and whose M2M Devices are currently or recently connected. Users may be deemed proximate to other users based on a number of criteria. In one embodiment, users are proximate if they are connected to M2M devices on the same wireless mesh network. In another embodiment, users are proximate if they are within a particular distance from each other (e.g., 100 meters). The Web Service environment contains matching algorithms and other services that identify Interest and Affiliation matches. If two users have a specific interest or affiliation in common, each of the user's handheld software profile on their handheld device produces a notification alert. Users may have one or more interests and/or affiliations in common. The resident handheld software will prioritize those users with the most matches at the top of the notification list. Each user is therefore able to exchange text messages with other matched users over established M2M Device connections, as long as the users maintain proximity with each other.

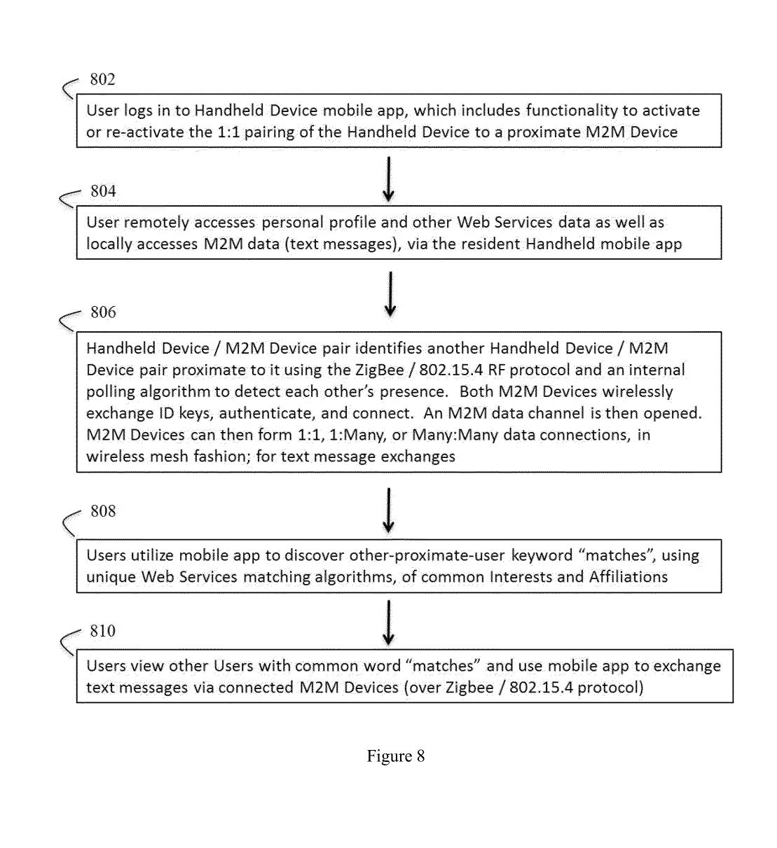

FIG. 8 is a flow diagram of one embodiment of user interaction with the Handheld Device subsystem. At step 802, a User logs into the mobile app sign-in screen using log-in credentials created and validated through interaction between a Handheld-resident mobile app and Web Services back-end environment. The Handheld-resident mobile application processes user login credentials and delivers them to the Web Services back-end for authentication, processing, and matching. Also at step 802, upon successful mobile app log-in, the mobile app launches an internal “find M2M Device” command to ascertain whether the mobile app can “pair” or “re-pair” with a proximate M2M Device. If an available M2M Device is nearby, the mobile app will pair the two Devices (Handheld and M2M) automatically, using specialized Bluetooth Low Energy (“BLE”) commands within the mobile app to create or confirm the pairing.

At step 804 using the mobile app, users can build (or import from other software applications they use) a User Profile, which includes building a list of Interests and Affiliations. The user may add, edit, or update these lists at any time, create specific profiles for certain times of day (e.g., “Work Day-Lunch Time”), or location (e.g., “San Francisco Medical Conference”). The mobile app enables users to be made aware when others using the same System are nearby using ZigBee and the 802.15.4 RF protocol. In one embodiment, the mobile app notifies users via the Handheld Device that other users with matching preferences are within proximity to the user. Simple text messages can also be exchanged using the mobile app and this same protocol.

At step 806, when any Handheld Device/M2M Device pair encounters other proximate Handheld Device/M2M Device pairs, the M2M Devices use specialized polling/beaconing algorithms to detect each other's presence, exchange ID keys, authenticate, and connect over Zigbee/802.15.4 (establish an M2M data connection bridge). It is appreciated that other protocols allowing such pairing and communication over a mesh network could be substituted for Zigbee/802.15.4. Using a combination of the mobile app being paired with its own M2M device (over BLE), and, subsequently, the M2M Device being connected to another M2M Device (over Zigbee/802.15.4), a data connection is thereby established between proximate Handheld Device subsystems. Users are both made aware, through the mobile app, that their devices are connected. Users of this System can form wireless “connections” via their paired M2M devices in one of three ways: 1:1; 1:Many; or Many:Many, in accordance with the ZigBee/802.15.4 wireless mesh networking standard.

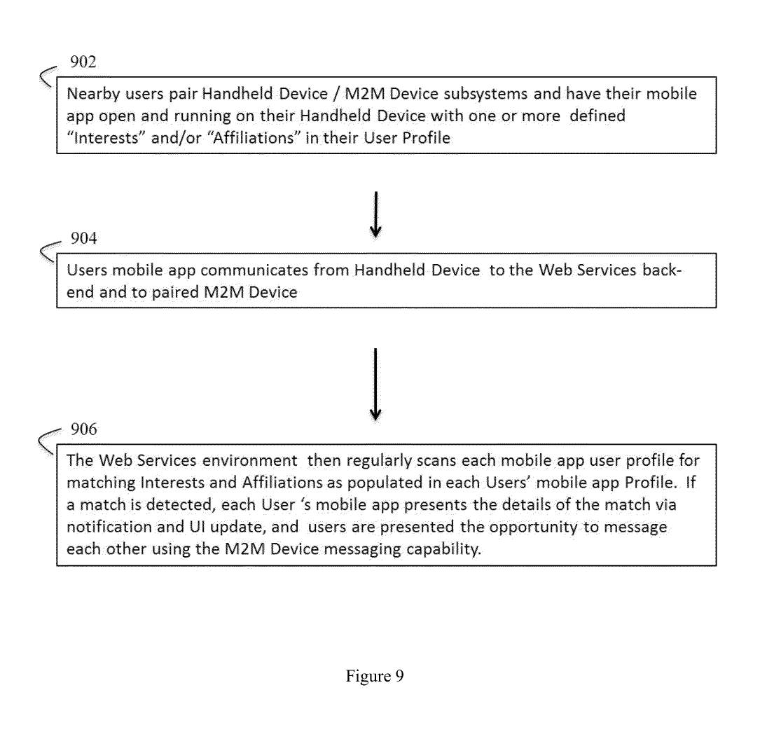

At step 808, when one or more users are connected, the mobile app uses specialized matching algorithms to look for keyword “matches” with proximate, connected users, according to the process described in FIG. 9.

At step 810, users who list one or more of the same Interests or Affiliations in their User Profile will be notified via the mobile app. For example, if two proximate users have the words “cancer vaccine” listed as an active “interest” or “Dartmouth Alumni Class of 1983” as an “affiliation,” matching algorithms running in the Web Services environment and the mobile app will alert both users of these “matches.”

FIG. 9 is a flowchart of the process of matching proximate users using predefined preferences introduced in FIG. 6 between the Handheld Device subsystem and the Web Server subsystem. At step 902, the Web Server subsystem matching algorithm 902 pairs two or more Handheld Device subsystem users that are proximate to each other. Each of the Users' mobile apps have an active User Profile that can include their Interests and Affiliations. At step 904, using the scenario described in step 902 and further assuming that each User has an active internet connection of some sort on their Handheld Device, each Users' mobile app is able to communicate (pass data) from Handheld Device to the Web Server back-end and simultaneously to their paired M2M Device. At step 906, if any two (or more) users of the overall System remain proximate to each other, and continue to meet the scenario in steps 902 and 904 above, the Web Server environment regularly scans each mobile app user profile for matching Interests and/or Affiliations, as populated in each Users' mobile app Profile. Should the Web Services matching algorithm detect a match, each User's mobile app presents the details of the match via notification and User Interface (UI) update (specifically, which Interests and Affiliations match, and with whom), and are presented the opportunity to message each other using the M2M Device messaging capability, as driven by the mobile app and its interactions with the Web Services environment subsystem.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the foregoing description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A method of using a wireless mesh network for social networking, comprising:
pairing a first handheld device with a first machine to machine networking device associated with a first user;
pairing a second handheld device with a second machine to machine networking device associated with a second user;
matching the first user with at least the second user over a wireless mesh network; and
communicating the match to at least the first user.

2. The method of claim 1, wherein the machine to machine networking devices comprise a first radio for communicating with the handheld device, and a second radio for communicating with other machine to machine networking devices.

3. The method of claim 2, wherein the first radio comprises an IEEE 802.15.4 communication module.

4. The method of claim 2, wherein the second radio comprises a Bluetooth Low Energy communication module.

5. The method of claim 1, wherein the machine to machine networking devices further comprise an integrated power source and a microprocessor.

6. The method of claim 1, wherein the matching comprises determining the first and second user have at least one defined preference in common.

7. The method of claim 6, wherein the at least one defined preference includes a preferred time of day to meet users.

8. The method of claim 6, wherein the at least one defined preference includes a recommended location to meet users.

9. The method of claim 1, wherein the wireless mesh network comprises machine to machine networking devices communicating within a defined range.

10. The method of claim 9, wherein the defined range is less than one hundred meters.

11. The method of claim 1, wherein the first machine to machine networking device is integrated into the first handheld device.

12. The method of claim 1, wherein the handheld device comprises a smartphone.

13. The method of claim 1, wherein the handheld device comprises a tablet.

14. The method of claim 1, wherein the handheld device comprises a personal digital assistant.

15. The method of claim 1, wherein the first handheld device is paired to only one machine to machine device at one time.

16. The method of claim 1, wherein the machine to machine networking devices communicate using text messages.

17. The method of claim 1, wherein users are matched if they are in proximity to each other.

18. The method of claim 17, wherein users are in proximity to each other if their machine to machine devices are part of the same wireless mesh network.

19. The method of claim 17, wherein users are in proximity to each other if they are less than one hundred meters apart.

20. A machine to machine network device for enabling social networking between individuals through mesh networking, comprising:
a microprocessor;
a power source;
a first radio comprising an Bluetooth Low Energy communication module for communicating with a handheld device; and
a second radio comprising an IEEE 802.15.4 communication module for communicating with other machine to machine devices;

21. The device of claim 20 wherein the machine to machine networking device is integrated into a handheld device.

22. The device of claim 20 wherein the microprocessor is programmed to connect the first radio to one handheld device at a time.

23. The device of claim 20 wherein the handheld device comprises a smartphone.

24. The device of claim 20 wherein the handheld device comprises a tablet.

25. The device of claim 20, wherein the handheld device comprises a personal digital assistant.

26. A system for social networking via a wireless mesh network, comprising:
a first handheld device paired to a first machine to machine communication device associated with a first user;
a second handheld device paired to a second machine to machine communication device associated with a second user;
wherein the first user is matched with at least the second user over a wireless mesh network; and
wherein the match is communicated to at least the first user.

27. The system of claim 26 wherein each machine to machine communication device comprises:
a first radio configured to communicate with the handheld device; and
a second radio configured to communicate with other machine to machine devices.

28. The system of claim 27 wherein the second radio comprises a Bluetooth Low Energy communication module.

29. The system of claim 27 wherein the first radio comprises an IEEE 802.15.4 communication module.

30. The system of claim 26, wherein the machine to machine networking device further comprises an integrated power source and a microprocessor.

31. The system of claim 26, wherein the matching comprises determining the first and second user have at least one defined preference in common.

32. The system of claim 31, wherein the at least one defined preference includes a preferred time of day to meet users.

33. The method of claim 31, wherein the at least one defined preference includes a recommended location to meet users.

34. The system of claim 26, wherein the wireless mesh network comprises machine to machine networking devices communicating within a defined range.

35. The method of claim 34, wherein the defined range is less than one hundred meters.

36. The system of claim 26, wherein the first machine to machine networking device is integrated into the first handheld device.

37. The system of claim 26, wherein the handheld device comprises a smartphone.

38. The system of claim 26, wherein the handheld device comprises a tablet.

39. The system of claim 26, wherein the handheld device comprises a personal digital assistant.

40. The system of claim 26, wherein the first handheld device is paired to only one machine to machine device at one time.

41. The system of claim 26, wherein the machine to machine networking devices communicate using text messages.

42. The system of claim 26, wherein users are matched if they are in proximity to each other.

43. The system of claim 42, wherein users are in proximity to each other if their machine to machine devices are part of the same wireless mesh network.

44. The system of claim 42, wherein users are in proximity to each other if they are less than one hundred meters apart.
